(19) United States
(12) Patent Application Publication
(10) Pub. No.: US 2007/0212926 A1
(43) Pub. Date: Sep. 13, 2007

(54) Protection hood for endoscope and endoscope including the same

(75) Inventors: Yoshinori Nakaura, Akishima-shi (JP); Kiyokazu Hosaka, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/707,727

(22) Filed: Feb. 16, 2007

(30) Foreign Application Priority Data
Mar. 10, 2006 (JP) 2006-065574

(51) Int. Cl. H01R 13/58

(52) U.S. Cl. 439/465

(57) ABSTRACT

A protection hood for an endoscope is arranged on the outer surface of an elongated tubular member, such as an insertion section or a universal cable of an endoscope. The protection hood includes a plurality of segments. The split segments include flat surfaces which are in contact with each other when a plurality of split segments are aligned with each other in the direction perpendicular to the axial direction of the protection hood and are combined into a tubular assembly. The split segments further include holding members, arranged on the flat surfaces, for holding the combined split segments in a tubular state.

### CROSS-REFERENCE TO RELATED APPLICATIONS

This application is based upon and claims the benefit of priority from prior Japanese Patent Application No. 2006-065574, filed Mar. 10, 2006, the entire contents of which are incorporated herein by reference.

### BACKGROUND OF THE INVENTION

1. Field of the Invention

The present invention relates to a protection hood for an endoscope adapted for various purposes, and an endoscope including the protection hood.

2. Description of the Related Art

In an endoscope including an insertion section provided with a protection hood, to attach the protection hood to the insertion section during manufacture the endoscope, the insertion section is connected to an operation section, and after that, the distal end of the insertion section is inserted into the protection hood that is tubular. While the inner surface of the protection hood is being in contact with the outer surface of the insertion section, the protection hood is moved from the distal end of the insertion section to the proximal end thereof across the whole length of the insertion section in such a manner that the protection hood is pulled toward the proximal end of the insertion section. The protection hood is then fixed such that a small-diameter portion of the protection hood covers the proximal end part of the insertion section and a large-diameter portion thereof is attached to the distal end of the operation section. The workability of pulling the protection hood is low because frictional resistance is high.

Jpn. Pat. Appln. KOKAI Publication No. 8-56893 discloses an endoscope in which the outer diameter of the proximal end of an insertion section is larger than that of the distal end thereof. Accordingly, when the insertion section is inserted into a tubular protection hood, a frictional resistance at the distal end of the insertion section is low.

### BRIEF SUMMARY OF THE INVENTION

According to one aspect of the present invention, there is provided a protection hood for an endoscope, the protection hood being arranged on the outer surface of an elongated tubular member of the endoscope, the protection hood including a plurality of split segments obtained by splitting the protection hood in the axial direction thereof, and at least one holding member, arranged in at least one of the split segments, for holding the combined split segments in a tubular state.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram illustrating an endoscope according to a first embodiment of the present invention;

FIG. 2A is a schematic perspective view of a plurality of a split segments of the protection hood for the endoscope in a closed state according to the first embodiment;

FIG. 2B is a schematic perspective view of a plurality of a split segments of the protection hood for the endoscope in an open state according to the first embodiment;

FIG. 3A is a schematic perspective view of a plurality of a split segments of the protection hood for the endoscope in a closed state according to a second embodiment of the present invention;

FIG. 3B is a schematic perspective view of a plurality of a split segments of the protection hood for the endoscope in an open state according to the second embodiment;

FIG. 4A is a schematic perspective view of a plurality of a split segments of the protection hood for the endoscope in a closed state according to a third embodiment of the present invention;

FIG. 4B is a schematic perspective view of a plurality of a split segments of the protection hood for the endoscope in an open state according to the third embodiment;

FIG. 5A is a schematic perspective view of a plurality of a split segments of the protection hood for the endoscope in an open state according to a fourth embodiment of the present invention;

FIG. 5B is a schematic perspective view of a plurality of a split segments of the protection hood for the endoscope in a closed state according to the fourth embodiment;

FIG. 5C is a schematic perspective view of a plurality of a split segments of the protection hood for the endoscope in a closed state according to the fourth embodiment;

FIG. 6A is a schematic perspective view of a protection hood according to a modification of the first to fourth embodiments of the present invention, each split segment including curved contact surfaces; and

FIG. 6B is a schematic perspective view of a protection hood according to another modification of the first to fourth embodiments of the present invention, each split segment including jaggy contact surfaces.

### DETAILED DESCRIPTION OF THE INVENTION

Preferred embodiments of the present invention will be described below with reference to the drawings.

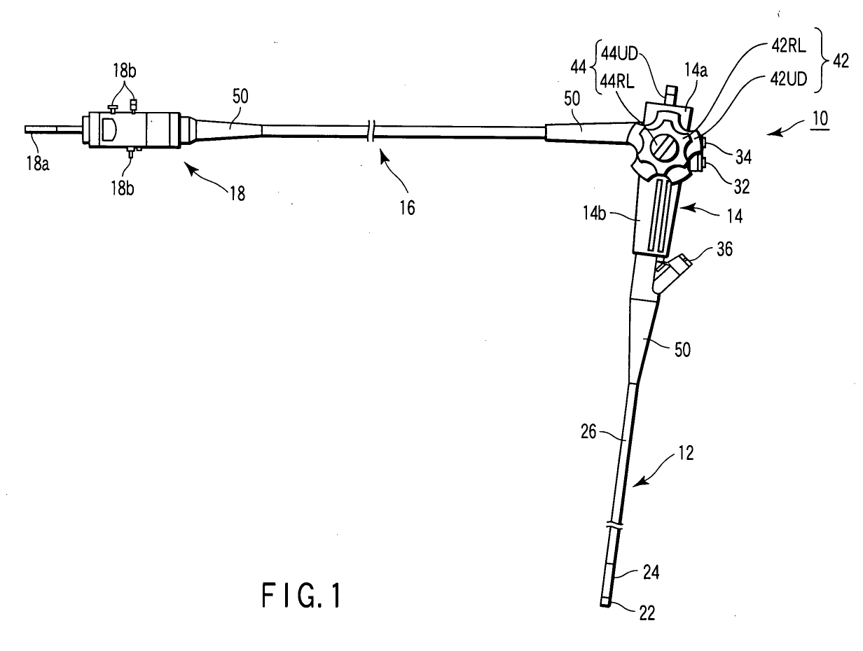

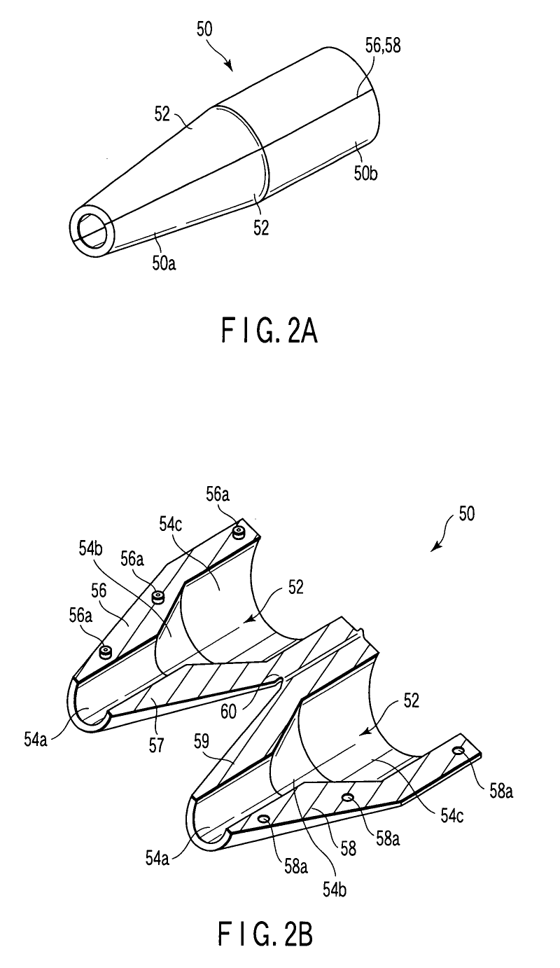

A first embodiment will now be described with reference to FIGS. 1 to 2B.

Referring to FIG. 1, an endoscope 10 includes an elongated insertion section 12, an operation section 14 disposed at the proximal end of the insertion section 12, a universal cable 16 extending from the operation section 14, and a connector 18 arranged at the end of the universal cable 16 remote from the operation section 14.

The insertion section 12 includes a rigid distal end portion 22, a bending portion 24 arranged at the proximal end of the rigid distal end portion 22, and a flexible tube 26 disposed at the proximal end of the bending portion 24. The proximal end of the flexible tube 26 is connected to the operation section 14. In the rigid distal end portion 22, an observation optical system, an imaging device, an illumination optical system, an air/water nozzle, and a forceps opening, which are not shown, are arranged.

The operation section 14 includes a operation section body 14a and a grip 14b which is adjacent to the insertion section 12. The body 14a has a suction control valve 32 and an air/water valve 34 arranged in parallel. A forceps valve 36 is detachable from the grip 14b of the operation section 14.

The suction control valve 32 is used for switching between suction channels (not shown). The air/water valve 34 is used for air/water supply in cleaning an objective of the observation optical system with liquid and blowing air to eliminate the liquid on the objective.

Angle knobs 42 (first and second bending operation knobs 42UD and 42RL) and holding levers 44 (first and second engaging levers 44UD and 44RL) are attached to the operation section 14. Each of the knobs and levers is made of a hard resin material.

The first bending operation knob 42UD is operated to bend the bending portion 24 of the insertion section 12 upward or downward. The second bending operation knob 42RL is operated to bend the bending portion 24 of the insertion section 12 rightward or leftward that is deviated from the upward-downward direction by 90°. The first engaging lever 44UD is operated to hold the first bending operation knob 42UD in a desired state. In other words, the first engaging lever 44UD is used for holding the upwardly or downwardly curved state of the bending portion 24. The second engaging lever 44RL is operated to hold the second bending operation knob 42RL in a desired state. In other words, the second engaging lever 44RL is used for holding the leftwardly or rightwardly curved state of the bending portion 24.

The universal cable 16 is covered with a resin material, e.g., polyurethane. The connector 18 is attached to the end of the universal cable 16 remote from the operation section 14. The connector 18 is made of a hard resin material.

The connector 18 includes a light guide connector 18a, an electric connector (not shown), and connectors 18b for suction and air/water supply. The light guide connector 18a is arranged for guiding illumination light emitted from a light source in order to illuminate an object to be observed with the illumination light applied from the distal end of the insertion section 12 through the illumination optical system. Light reflected from the illuminated object is electrically transmitted through the distal end of the insertion section 12 and the observation optical system to the electric connector.

Protection hoods 50 are arranged in a proximal end part of the flexible tube 26 of the insertion section 12 and both end parts of the universal cable 16, respectively. Accordingly, if a large force is applied to a tubular member, such as the flexible tube 26 or the universal cable 16, the arranged protection hood 50 prevents the tubular member from buckling at its end part. Each protection hood 50 is made of a polymeric material, such as a rubber material or a resin material.

Referring to FIG. 2A, a distal end portion 50a of each protection hood 50 is smaller than a proximal end portion 50b thereof in both inner and outer diameters. The tip of the distal end portion 50a of each protection hood 50 is directed toward the middle of the associated tubular member, such as the distal end of the flexible tube 26 or middle part of the universal cable 16.

Referring to FIG. 2B, each protection hood 50 is composed of a pair of split segments 52, each of which is shaped like a halfpipe. Each split segment 52 has a pair of surfaces (split parts), which are formed in such a manner that the protection hood 50 is split into two segments with respect to one plane extending along the axis of the protection hood 50. The inner surface of each split segment 52 has a small-diameter portion 54a, a medium-diameter portion 54b, and a large-diameter portion 54c. Each of the small-diameter portion 54a and the large-diameter portion 54c has a substantially constant diameter. On the other hand, the medium-diameter portion 54b is tapered so as to smoothly connect the small-diameter portion 54a and the large-diameter portion 54c. Specifically, the end of the medium-diameter portion 54b adjacent to the small-diameter portion 54a is smaller than that adjacent to the large-diameter portion 54c in diameter. The outer surface of each split segment 52 is tapered such that the outer diameter thereof gradually increases from the tip of the distal end portion 50a toward the proximal end portion 50b. The outer diameter of each split segment 52 becomes large in the vicinity of a portion corresponding to the boundary between the medium-diameter portion 54b and the large-diameter portion 54c on the inner surface.

The inner diameter of the small-diameter portion 54a is slightly smaller than or equal to the outer diameter of the tubular member, such as the flexible tube 26 or the universal cable 16. When the inner diameter of the small-diameter portion 54a is slightly smaller than the outer diameter of the tubular member, the tubular member is elastically deformed such that the outer diameter of an outer sheath of the tubular member is reduced, and/or the protection hood 50 is elastically deformed such that the inner diameter of the small-diameter portion 54a is increased. Therefore, the inner surface of the small-diameter portion 54a is brought into tight contact with the outer surface of the tubular member. In other words, the small-diameter portion 54a functions as contact means and also serves as a seal. An adhesive or a sealant may be applied between the small-diameter portion 54a and the proximal end part of the flexible tube 26 and between each small-diameter portion 54a and the associated outer surface of the universal cable 16.

Each split segment 52 has a pair of split parts, i.e., first and second parts to align the split segments 52 with each other. The pair of split segments 52 has first flat surfaces (contact surfaces) 56 and 58, formed by split as described above, on one side (in the first split parts). On the other side (in the second split parts), the pair of split segments 52 has second flat surfaces (contact surfaces) 57 and 59 formed by split and a hinged connecting portion 60 connecting the second split parts of the split segments 52. Accordingly, part of each split segment 52 in the vicinity of the connecting portion 60 is thinner than the other part thereof.

The first flat surface 56 of the one split segment 52 has a plurality of projections (holding members) 56a which project from the first flat surface 56 in a direction, for example, perpendicular to the first flat surface 56. The first flat surface 58 of the other split segment 52 has a plurality of recesses (holding members) 58a which are recessed from the first flat surface 58 in a direction perpendicular thereto. When the first flat surfaces 56 and 58 of the split segments 52 are rotated about the connecting portion 60 and are brought into contact with each other, the above-mentioned projections 56a are engaged with the recesses 58a, respectively. With this engagement, the pair of split segments 52 serves as the tubular protection hood 50.

A method of arranging the protection hood 50 according to the present embodiment in the proximal end part of the flexible tube 26 will now be described.

First, the proximal end of the flexible tube 26 of the insertion section 12 is connected to the operation section 14. Subsequently, the protection hood 50 is attached to the proximal end part of the flexible tube 26 of the insertion section 12. In this case, the protection hood 50 is split by pivoting the split segments 52 about the connecting portion 60 in opposite directions. In this state, the proximal end part of the flexible tube 26 is fitted into the small-diameter portion 54a of one of the split segments 52. The projections 56a on the first flat surface 56 of the split segment 52 are engaged with the recesses 58a on the first flat surface 58 of the other split segment 52. In this instance, the first flat surfaces 56 and 58 are joined with an adhesive (serving as a holding member) so that the first flat surfaces 56 and 58 are held in contact with each other. Simultaneously, the proximal end portion 50b of the protection hood 50 is fixed to the distal end of the operation section 14 in such a manner that the large-diameter portion 54c of the protection hood 50 is joined to an attachment portion (not shown) in distal end part of the operation section 14 with the adhesive.

The protection hoods 50 are arranged in both the end parts of the universal cable 16 in a manner similar to the above.

As described above, the present embodiment has the following advantages.

The protection hood 50 can be attached to the proximal end part of the flexible tube 26 of the insertion section 12 or the universal cable 16 by merely joining the pair of split segments 52 nearly separated. Accordingly, it is unnecessary to perform a troublesome operation, for example, insert the insertion section 12 through the protection hood 50 such that the protection hood 50 is moved from the distal end of the insertion section 12 to the proximal end thereof against frictional resistance. Advantageously, the above structure can prevent the application of a load resulting from the frictional resistance to the insertion section 12 and the universal cable 16, leading to a reduction in the number of man-hours required for manufacturing the endoscope 10 and a reduction in manufacturing cost.

In the present embodiment, the protection hood 50 is composed of a pair of split segments 52. The number of split segments 52 may be changed as appropriate. For example, the protection hood 50 may include three split segments 52. In this construction (not shown), a first split segment 52 has a first flat surface 56 on one side (in first split part) and has a connecting portion 60 on the other side (in second split part). A second split segment 52 has the connecting portion 60 on one side (corresponding to the second split part of the first split segment 52) and another connecting portion 60 on the other side (corresponding to second split part of a third split segment 52). The third split segment 52 has a first flat surface 58 on one side (in first split part) and has the connecting portion 60 on the other side (in the second split part). Therefore, if the number of split segments 52 is three or more, the split segments 52 are aligned (i.e., combined) with one other in the direction perpendicular to the axes of the split segments 52, thus forming the tubular protection hood 50. The tubular state of the protection hood 50 is held by an adhesive or engaging members (projections 56a and recesses 58a) in the first split parts (the first flat surfaces 56, 58), serving as an openable end of the protection hood 50.

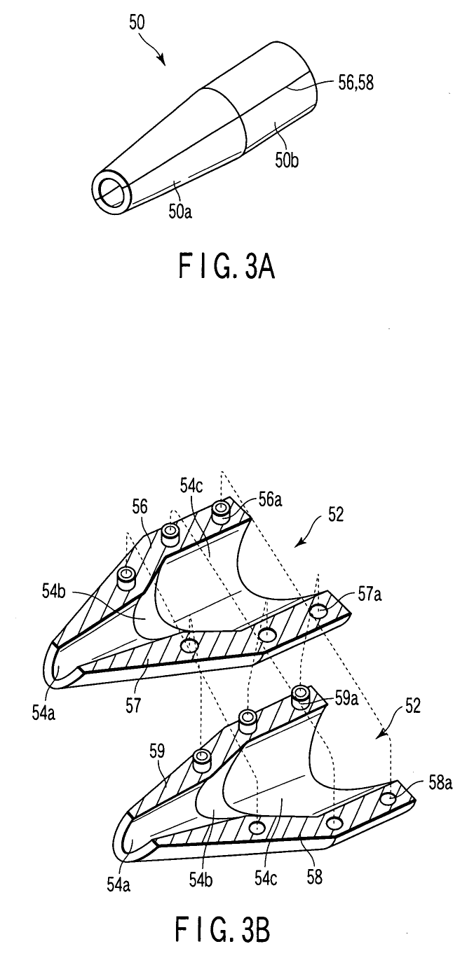

A second embodiment will now be described with reference to FIGS. 3A and 3B. The present embodiment is a modification of the first embodiment. The same components as those described in the first embodiment are designated by the same reference numerals and a detailed description thereof is omitted. The same applies to third and fourth embodiments.

Referring to FIGS. 3A and 3B, two split segments 52 of a protection hood 50 are completely separated. One of the split segments 52 has a pair of first and second flat surfaces (contact surfaces) 56 and 57. The other split segment 52 has a pair of first and second flat surfaces (contact surfaces) 58 and 59. The second flat surface 57 of the split segment 52 has a plurality of recesses (holding members) 57a recessed perpendicular to the second flat surface 57. The second flat surface 59 of the other split segment 52 has a plurality of projections (holding members) 59a projecting from the second flat surface 59 in the direction perpendicular thereto.

In attaching the split segments 52 of the protection hood 50 to each other, the first flat surface 56 of the split segment 52 is brought into contact with the first flat surface 58 of the other split segment 52 and the second flat surface 57 of the split segment 52 is brought into contact with the second flat surface 59 of the other split segment 52. Projections 56a in the first flat surface 56 of the split segment 52 are engaged with recesses 58a in the first flat surface 58 of the other split segment 52, respectively. Similarly, the recesses 57a in the second flat surface 57 of the split segment 52 are engaged with the projections 59a in the second flat surface 59 of the other split segment 52, respectively. This engagement enables the protection hood 50 to have a tubular state.

Therefore, it is unnecessary to perform a troublesome operation in a manner similar to the first embodiment. Advantageously, the above structure can prevent the application of a load to an insertion section 12 and a universal cable 16. The tubular protection hoods 50 can be attached to tubular members, such as the insertion section 12 and the universal cable 16.

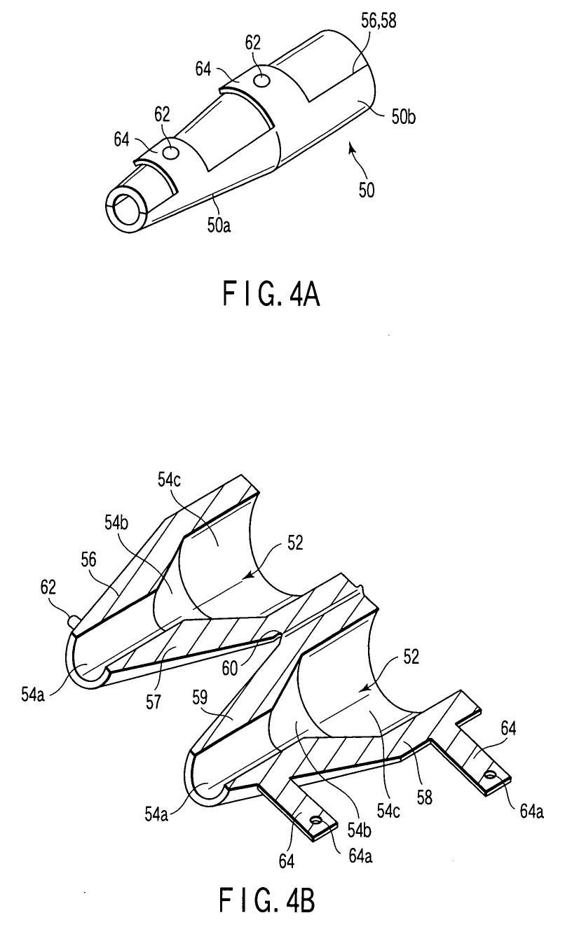

A third embodiment will now be described with reference to FIGS. 4A and 4B.

Referring to FIGS. 4A and 4B, the outer surface of one split segment 52 of a protection hood 50 includes two projections (retaining portions) 62 integrally formed. One of the projections 62 is disposed in a distal end portion 50a of the protection hood 50 and the other projection 62 is arranged in a proximal end portion 50b thereof. A first flat surface 58 of the other split segment 52 has two sheet-like bands (holding members) 64 projecting from one end of a first flat surface 58. One of the bands 64 is arranged in the distal end portion 50a and the other band 64 is disposed in the proximal end portion 50b. Each band 64 has a through hole 64a at its end. Each projection 62 and its through hole 64a have such a positional relationship that when first flat surfaces 56 and 58 in first split parts (on one side) of the split segments 52 are brought into contact with each other, the center of each through hole 64a is slightly hard to reach the corresponding projection 62. Therefore, each band 64 is slightly elastically deformed, thus engaging the through hole 64a thereof with the corresponding projection 62. This arrangement prevents the split segments 52 from separating from each other. On the other side (in second split parts), the split segments 52 have second flat surfaces 57 and 59 and a hinged connecting portion 60 connecting the second split parts of the split segments 52.

A method of arranging the protection hood 50 according to the present embodiment to the proximal end part of the insertion section 12 will now be described.

First, the insertion section 12 is connected to the operation section 14. Subsequently, the protection hood 50 is attached to the proximal end part of the flexible tube 26 of the insertion section 12. In this case, the protection hood 50 is split by pivoting the split segments 52 about the connecting portion 60 in opposite directions. In this state, the proximal end part of the flexible tube 26 is fitted into a small-diameter portion 54a of one of the split segments 52. The first flat surfaces 56 and 58 are joined with an adhesive (serving as a holding member) so that the first flat surfaces 56 and 58 are held in contact with each other. Simultaneously, the proximal end portion 50b of the protection hood 50 is joined to the distal end of the operation section 14.

Further, each projection 62 is engaged with the corresponding through hole 64a of the band 64. Consequently, even if the inner diameter of the small-diameter portion 54a of the protection hood 50 is slightly smaller than the outer diameter of the flexible tube 26 or a universal cable 16, the protection hood 50 can be held in a tubular shape by the split segments 52.

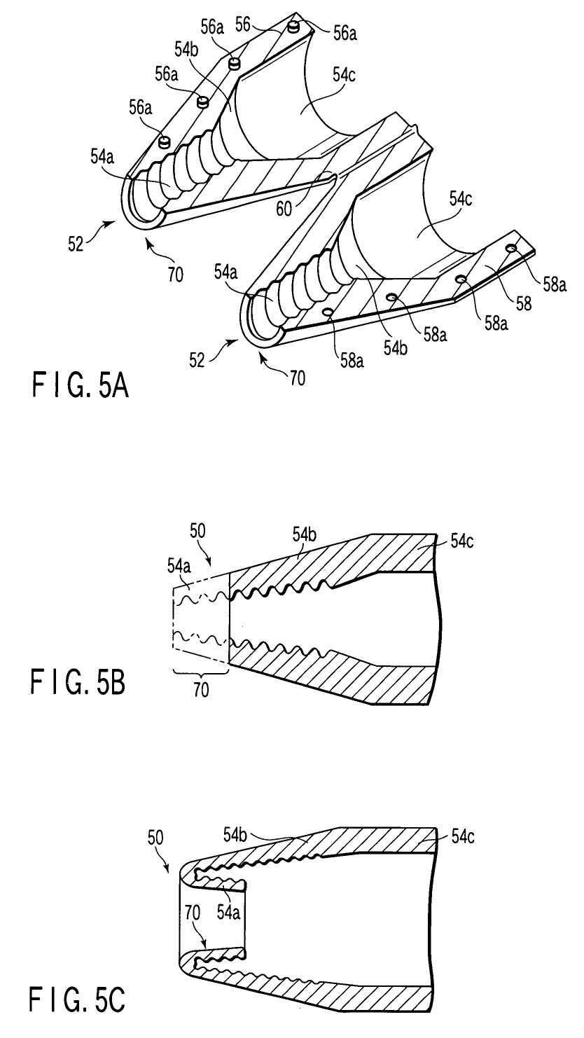

A fourth embodiment will now be described with reference to FIGS. 5A to 5C.

Referring to FIG. 5A, in a protection hood 50, the inner surface of a small-diameter portion 54a and that of a medium-diameter portion 54b have a series of half-ring-shaped recesses. The small-diameter portion 54a has thin part, indicated at 70 in FIG. 5A, in a region covering the proximal end part of the flexible tube 26. The thin part 70 is flexible like a bellows providing suitable flexibility. This part 70 may be cut so as to fit to the outer diameter of, for example, the proximal end part of the flexible tube 26 or a universal cable 16.

In other words, if the outer diameter of the flexible tube 26 or the universal cable 16 is slightly different from the inner diameter of the small-diameter portion 54a of the protection hood 50, the small-diameter portion 54a is cut to the proper length as shown in FIG. 5B. Thus, the protection hood 50 can be attached to the flexible tube 26 and the universal cable 16 having various outer diameters.

Referring to FIG. 5C, end part of the small-diameter portion 54a may be bent inwardly. Thus, the protection hood 50 with this arrangement can be attached to the flexible tube 26 and the universal cable 16 having various outer diameters such that the protection hood 50 is in close contact with the outer surface of the tube or cable. In this case, the small-diameter portion 54a serves as contact means which is in tight contact with the outer surface of a tubular member.

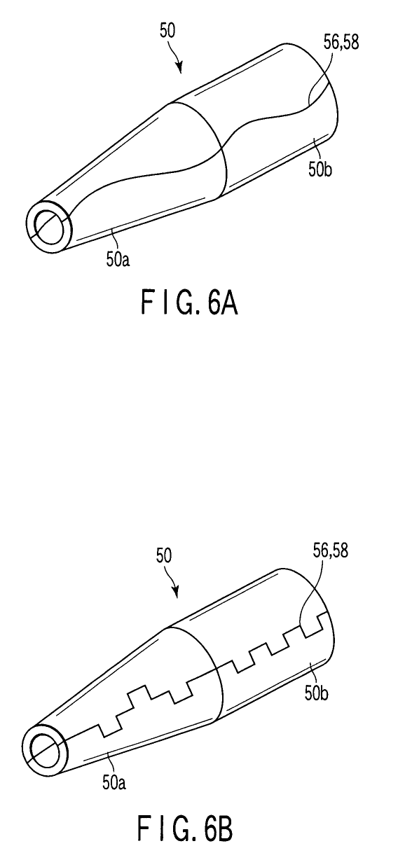

In the above-described first to fourth embodiments, the edge of each of the flat surfaces 56, 57, 58, and 59 is straight. Curved contact surfaces or jaggy contact surfaces may be used as shown in FIGS. 6A and 6B.

The protection hood 50 may be held in a tubular state by only the engagement between the projections (56a, 59a) and the recesses (57a, 58a) in the flat surfaces 56, 57, 58, and 59. Alternatively, the protection hood 50 may be held in a tubular state using the combination of the engagement between the projections (56a, 59a) and the recesses (57a, 58a) and the sheet-like bands 64 described in the third embodiment.

The flat surfaces 56 and 57 may be fixed to the respective flat surfaces 58 and 59 by means of an adhesive (serving as a holding member). In this case, the adhesive may be applied to one or both of the first flat surfaces 56 and 58 and to one or both of the second flat surfaces 57 and 59 before bringing the flat surfaces 56 and 57 into contact with the respective flat surfaces 58 and 59. Alternatively, a tape or sheet, whose both surfaces are covered with an adhesive, may serve as a holding member and be arranged on one or both of the first flat surfaces and one or both of the second flat surfaces.

In the first, third, and fourth embodiments, each protection hood 50 has such a structure that the connecting portion 60 is provided in the proximal end portion 50b and the distal end portion 50a is separated (i.e., the connecting portion 60 is not arranged in the distal end portion 50a). The structure is not limited to the above. The connecting portion 60 may be provided in the distal end portion 50a and the proximal end portion 50b may be separated (the connecting portion 60 is not provided in the proximal end portion 50b).

In the first, third, and fourth embodiments, the hinged thin connecting portion 60 is disposed on the outer surface of the proximal end portion 50b. The structure is not limited to the above. The connecting portion 60 may be arranged between the outer surface and the inner surface of the proximal end portion 50b, alternatively, may be arranged on the inner surface thereof. In the former case, the outer surface and the inner surface serve as split parts. In the latter case, the outer surface serves as split part.

In the respective embodiments, the following structure may be used: Projections (or grooves) are arranged on the inner surface of the large-diameter portion 54c of each split segment 52 and grooves (or projections) to be engaged with the projections (or grooves) are arranged on the outer surface of an attachment portion in distal end part of the operation section 14. The protection hood 50 may be fixed to the operation section 14 by the engagement between the projections and the grooves.

The protection hood 50 has such a structure that the inner diameter of each of the small-diameter portion 54a and the large-diameter portion 54c is substantially constant. The structure is not limited to the above. The inner diameter of each portion may be changed gradually or in a stepwise fashion. To attach the proximal end portion 50b of the protection hood 50 to the distal end part of the operation section 14, a screw mounting hole may be formed in the proximal end portion 50b of the protection hood 50 in the direction perpendicular to the axis of the protection hood 50, a screw mounting hole may also be formed in the attachment portion in the distal end part of the operation section 14, and a screw may be inserted into the mounting holes, thus attaching the protection hood 50 to the operation section 14.

In the above-described embodiments, the whole protection hood 50 is made of the polymeric material. The structure is not limited to the above. The whole or part of the large-diameter portion 54c to be fixed to the attachment portion of the distal end part of the operation section 14 may include metal (e.g., aluminum) split segments and the medium-diameter portion 54b and the small-diameter portion 54a may include split segments made of a polymeric material.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A protection hood for an endoscope, the protection hood being arranged on the outer surface of an elongated tubular member of the endoscope, the protection hood comprising:
a plurality of split segments obtained by splitting the protection hood in the axial direction thereof; and
at least one holding member, arranged in at least one of the split segments, for holding the combined split segments in a tubular state.

2. The protection hood according to claim 1, wherein the split segments include split parts obtained by splitting the tubular protection hood in the axial direction thereof.

3. The protection hood according to claim 2, wherein the split parts include contact surfaces respectively where the split parts of the split segments are in contact with each other.

4. The protection hood according to claim 3, wherein the holding member is an engaging member provided in each contact surface, the engaging member being engaged with the corresponding engaging member when the contact surfaces of the one split segment are in contact with the respective contact surfaces of the other split segment.

5. The protection hood according to claim 3, wherein the holding member includes:
a belt extending from the one split segment and winding the split segments to hold the protection hood in a tubular state; and
a retaining portion, arranged in at least one of the split segments, for retaining the belt.

6. The protection hood according to claim 2, wherein
each split segment includes a small-diameter portion, whose one end is adjacent to the middle of the tubular member in the axial direction thereof, and a large-diameter portion which is arranged at the other end of the small-diameter portion and whose diameter is larger than that of the small-diameter portion, and
the small-diameter portion includes contact portion to be deformed to the outer diameter of the tubular member and be in close contact with the outer surface of the tubular member.

7. The protection hood according to claim 1, wherein
each split segment includes a small-diameter portion, whose one end is adjacent to the middle of the tubular member in the axial direction thereof, and a large-diameter portion which is arranged at the other end of the small-diameter portion and whose diameter is larger than that of the small-diameter portion, and
the small-diameter portion includes contact portion to be deformed to the outer diameter of the tubular member and be in close contact with the outer surface of the tubular member.

8. The protection hood according to claim 1, wherein the split segments include split parts obtained by splitting the tubular protection hood in the axial direction thereof and a connecting portion for openably connecting the split segments.

9. The protection hood according to claim 8, wherein the split parts include contact surfaces respectively where the split parts of the split segments are in contact with each other.

10. The protection hood according to claim 9, wherein the holding member is an engaging member provided in each contact surface, the engaging member being engaged with the corresponding engaging member when the contact surfaces of the one split segment are in contact with the respective contact surfaces of the other split segment.

11. The protection hood according to claim 9, wherein the holding member includes:
a belt extending from the one split segment and winding the split segments to hold the protection hood in a tubular state; and
a retaining portion, arranged in at least one of the split segments, for retaining the belt.

12. The protection hood according to claim 8, wherein
each split segment includes a small-diameter portion, whose one end is adjacent to the middle of the tubular member in the axial direction thereof, and a large-diameter portion which is arranged at the other end of the small-diameter portion and whose diameter is larger than that of the small-diameter portion, and
the small-diameter portion includes contact portion to be deformed to the outer diameter of the tubular member and be in close contact with the outer surface of the tubular member.

13. An endoscope including a protection hood arranged on an elongated tubular member, the protection hood comprising:
a plurality of split segments including split parts obtained by splitting the protection hood in the axial direction thereof, wherein
the split segments are combined into a tubular assembly by allowing each split part to face to the corresponding split part.

14. The endoscope according to claim 13, wherein at least one of the split parts of the one split segment includes at least one holding member for holding a fixed state between the split part and the corresponding split part of the other split segment.

15. The endoscope according to claim 14, wherein the split parts include contact surfaces where the adjacent split segments of the split segments are in contact with each other.

16. The endoscope according to claim 13, wherein the split parts include contact surfaces where the adjacent split segments of the split segments are in contact with each other.
